(19) United States
(12) Patent Application Publication
(10) Pub. No.: US 2010/0264894 A1
(43) Pub. Date: Oct. 21, 2010

(54) SWITCH DRIVING CIRCUIT

(76) Inventor: Chih-Chia Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/717,123

(22) Filed: Mar. 3, 2010

(30) Foreign Application Priority Data
Apr. 17, 2009 (TW) 098112816

(51) Int. Cl. G05F 1/10

(52) U.S. Cl. 323/283; 323/282

(57) ABSTRACT

A switch driving circuit includes a buffer module, a capacitor module, a first switch module, a second switch module, and a control module. The buffer module generates a driving voltage according to a control voltage. The first switch module is turned on when the control voltage is at a low voltage level to provide a supply voltage to the buffer module and charge the capacitor module by the supply voltage to generate a compensation voltage. The second switch module is turned on when the control voltage is at a high voltage level to provide the compensation voltage to the buffer module. When the supply voltage is higher than a reference voltage, the control module turns on the first switch module and turns off the second module to provide the supply voltage to the buffer module.

### BACKGROUND OF THE INVENTION

1. Field of the Invention

The present invention is related to a switch driving circuit, and more particularly, to a switch driving circuit of increasing the driving voltage by a switch-mode capacitor when the supply voltage is lower.

2. Description of the Prior Art

FIG. 1 is a circuit diagram of a conventional boost converter 100. The boost converter 100 comprises a voltage source Vin, a transistor 101, a diode 102, an inductor 103, a capacitor 104, and a load 105. The transistor is controlled by a driving voltage Vd. The driving voltage Vd is a pulse width modulation (PWM) signal, generated by a switch driving circuit according to a control voltage. The switch driving circuit generates the driving voltage of the high voltage level by means of a supply voltage. When the supply voltage is lower, the voltage level of the driving voltage Vd generated by the switch driving circuit decreases as well. More particularly, the turn-on resistor RON of the transistor 101 is represented as the following formula:

$${R}_{on} = \frac{1}{{μ}_{n} {C}_{ox} \frac{W}{L} ( {V}_{gs} - {V}_{th} )}$$

wherein μn represents the mobility of the semiconductor surface carrier; Cox represents the capacitance per area of the gate; W represents the channel width; L represents the channel length; Vgs represents the gate-source voltage; and Vth represents the threshold voltage. Since the gate-source voltage Vgs of the transistor 101 is limited by the supply voltage, the turn-on resistance increases when the supply voltage becomes lower, reducing the performance of the boost converter 100.

### SUMMARY OF THE INVENTION

The present invention provides a switch driving circuit. The switch driving circuit comprises a buffer module, a capacitor module, a first switch module, a second switch module, and a control module. The buffer module is utilized for generating a driving voltage according to a control voltage. The capacitor module is electrically connected to the buffer module. The first switch module is turned on when the control voltage is at a low voltage level for providing a supply voltage to the buffer module and charging the capacitor module by the supply voltage so as to generate a compensation voltage. The second switch module is turned on when the control voltage is at a high voltage level for providing the compensation voltage to the buffer module. The control module is utilized for turning on the first switch module and turning off the second switch module so as to provide the supply voltage to the buffer module when the supply voltage is higher than a reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a conventional boost converter.

FIG. 2 is a circuit diagram of a boost converter.

FIG. 3 is a circuit diagram of the switch driving circuit.

FIG. 4 is a circuit diagram of the voltage-detecting circuit.

FIG. 5 is a diagram illustrating the equivalent circuit of the switch driving circuit when the detecting voltage is at the high voltage level.

FIG. 6 and FIG. 7 are diagrams illustrating the equivalent circuits of the switch driving circuit when the detecting voltage is at the low voltage level.

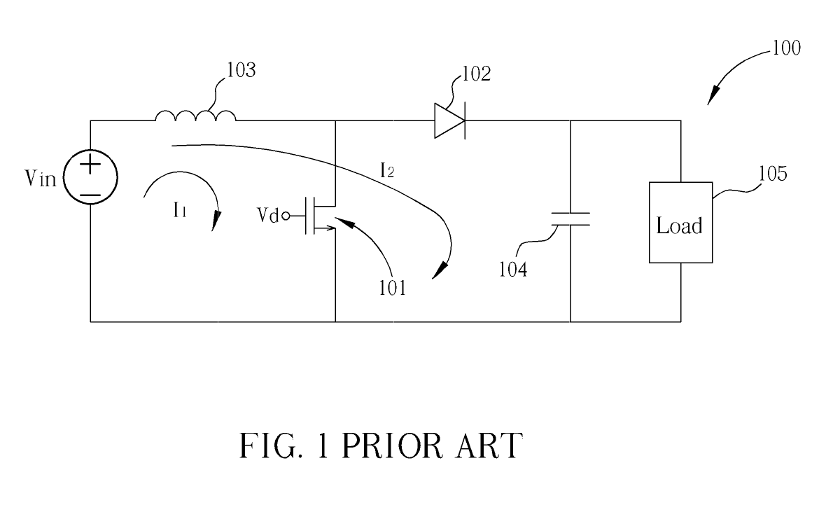

### DETAILED DESCRIPTION

The switch driving circuit of the present invention increases the driving voltage by a switch-mode capacitor. The switch driving circuit can be applied in various switch-mode circuits, e.g. a switch-mode DC/DC converter. In the present embodiment, the switch-mode DC/DC converter is set to be a boost converter as an example for explaining the operation of the switch driving circuit.

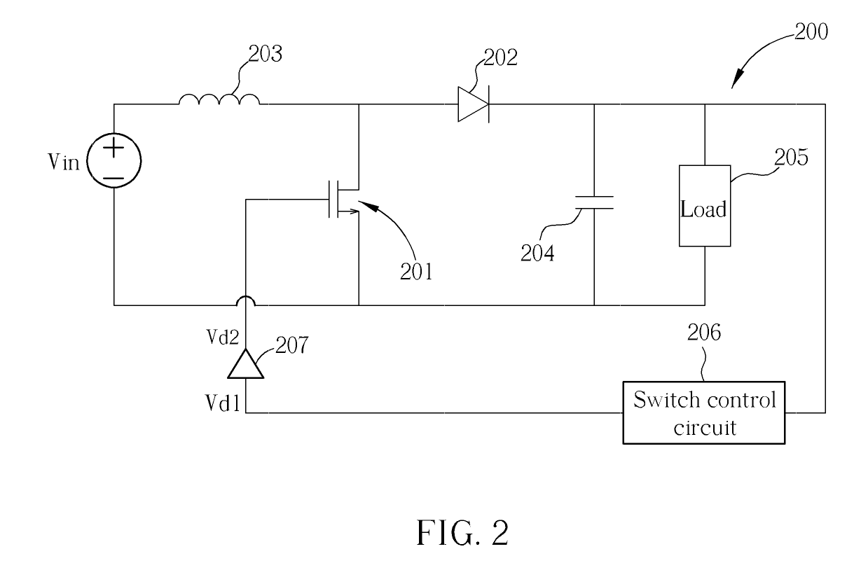

FIG. 2 is a circuit diagram of a boost converter 200. The boost converter 200 comprises a voltage source Vin, a switch component 201, a diode 202, an inductor 203, a capacitor 204, a load 205, a switch control circuit 206, and a switch driving circuit 207. The switch driving circuit 207 generates a driving voltage Vd2 according to a control voltage Vd1 generated by the switch control circuit 206. For instance, the switch component 201 is an NMOS transistor. The switch driving circuit 206 generates the driving voltage Vd2 of the high voltage level by means of a supply voltage. In the prior art, when the supply voltage is lower, the turn-on current between the drain and the source of the transistor is reduced, which means the turn-on resistance of the switch component 201 increases. However, in the present invention, the switch driving circuit 207 can generate a driving voltage high enough for avoiding the turn-on resistance of the switch component 201 increasing so as to improve the performance of the boost converter 200. The operational principle of the switch driving circuit 207 is illustrated as below.

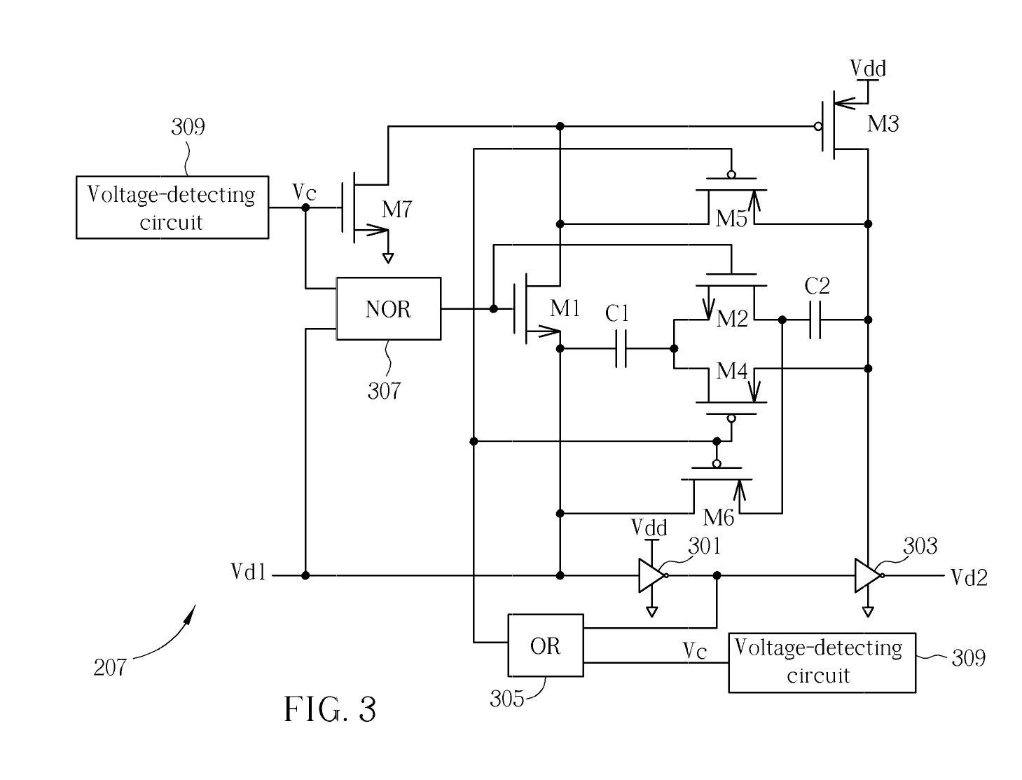

FIG. 3 is a circuit diagram of the switch driving circuit 207. The switch circuit 207 comprises a buffer module, a capacitor module, a first switch module, a second switch module, and a control module. The buffer module comprises a first inverter 301 and a second inverter 303. The capacitor module comprises a first capacitor C1 and a second capacitor C2. The first switch module comprises a first switch M1, a second switch M2, and a third switch M3. The second switch module comprises a fourth switch M4, a fifth switch M5, and a sixth switch M6. The control module comprises a voltage-detecting circuit 309, a NOR gate 307, an OR gate 305, and a seventh switch M7. The buffer module generates the driving voltage Vd2 according to the control voltage Vd1. The control voltage Vd1 is inputted from the input end of the first inverter 301. The output end of the first inverter 301 is electrically connected to the input end of the second inverter 303. The driving voltage Vd2 is outputted by the output end of the second inverter 303. The control module switches the first switch module and the second switch module according to the control voltage Vd1 so as to provide a supply voltage Vdd or a compensation voltage 1.5×Vdd to the first power end of the second inverter 303. There are three current paths between the input end of the first inverter 301 and the first power end of the second inverter 303. The first current path passes through the first capacitor C1, the second switch M2, and the second capacitor C2. The second current path passes through the first capacitor C1, and the fourth switch M4. The third current path passes through the sixth switch M6, and the second capacitor C2. In addition, the third switch M3 is electrically connected between the supply voltage Vdd and the first power end of the second inverter 303. The control end of the third switch M3 is electrically connected to the input end of the first inverter 301 through the first switch M1 and electrically connected to the first power end of the second inverter 303 through the fifth switch M5. The control ends of the first switch M1 and the second switch M2 are electrically connected to the NOR gate 307. The control ends of the fourth switch M4, the fifth switch M5, and the sixth switch M6 are electrically connected to the OR gate 305. The OR gate 305 and the NOR gate 307 are both electrically connected to the voltage-detecting circuit 309. Hence, when the detecting voltage Vc generated by the voltage-detecting circuit 309 is at a high voltage level, the seventh switch is turned on, so that the third switch is turned on as well and the other switches are all turned off. When the detecting voltage is at a low voltage level, the seventh switch is turned off. At the time, if the control voltage Vd1 is at a low voltage level, the first switch M1, the second switch M2, and the third switch M3 are turned on, and the fourth switch M4, the fifth switch M5, and the sixth switch M6 are turned off; if the control voltage Vd1 is at a high voltage level, the first switch M1, the second switch M2, and the third switch M3 are turned off, and the fourth switch M4, the fifth switch M5, and the sixth switch M6 are turned on. In addition, the first switch M1, the second switch M2, and the seventh switch M7 are NMOS transistors, and the third switch M3, fourth switch M4, the fifth switch M5, and the sixth switch M6 are PMOS transistors.

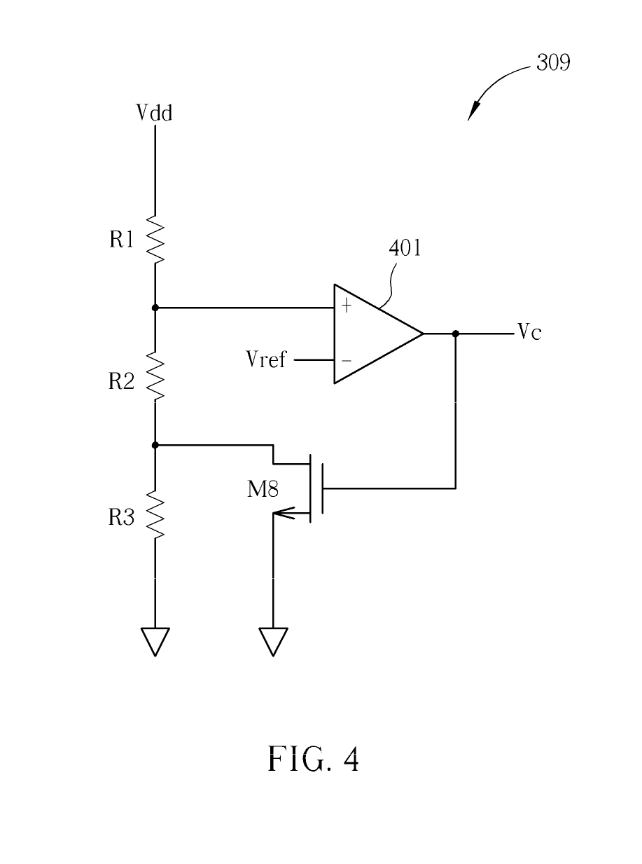

FIG. 4 is a circuit diagram illustrating the voltage-detecting circuit 309. The voltage-detecting circuit 309 detects if the supply voltage Vdd is higher than a reference voltage Vref. The voltage-detecting circuit 309 comprises a first resistor R1, a second resistor R2, a third resistor R3, an operational amplifier 401, and a transistor M8. The first resistor R1, the second resistor R2, and the third resistor R3 is connected in series between the supply voltage Vdd and the ground. The positive input end of the operational amplifier 401 is electrically connected to the first resistor R1. The negative input end the operational amplifier 401 receives the reference voltage Vref. The output end of the operational amplifier is electrically connected to the gate of the transistor M8. The transistor M8 and the third resistor R3 are connected in parallel. Therefore, when the partial voltage of the supply voltage Vdd is higher than the reference voltage Vref (that is, Vin×(R2+R3)/(R1+R2+R3)>Vref), the detecting voltage Vc is at the high voltage level.

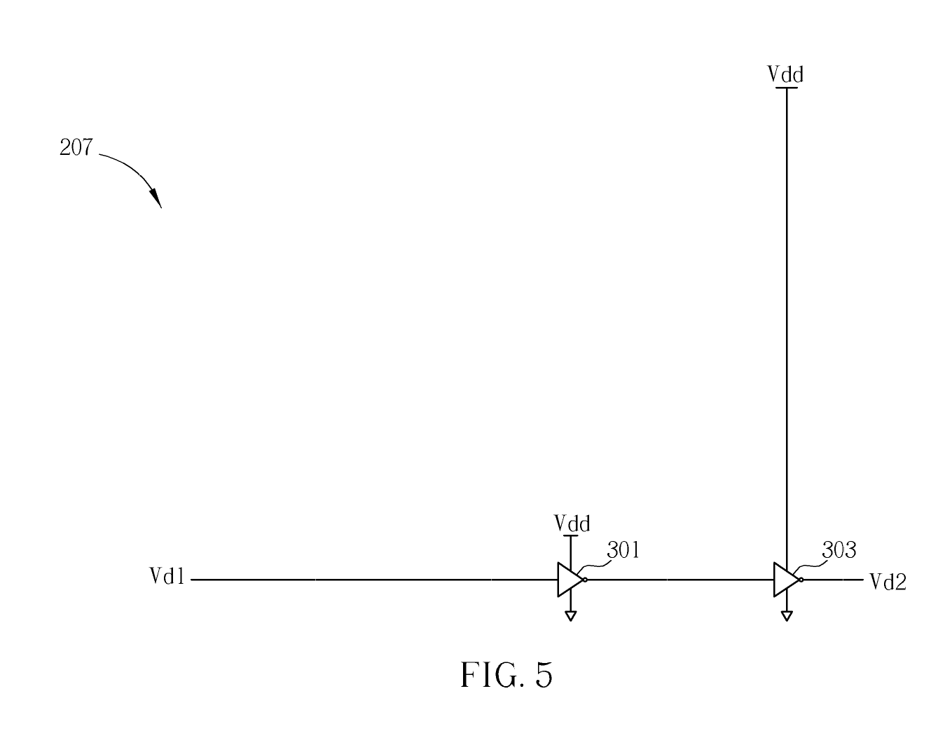

FIG. 5 shows an equivalent circuit of the switch driving circuit 207 when the detecting voltage Vc is at the high voltage level. When the detecting voltage Vc is at the high voltage level, the seventh switch M7 is turned on, so that the third switch M3 is turned on and the other switched are all turned off. As a result, the first power end of the second inverter 303 receives the supply voltage Vdd.

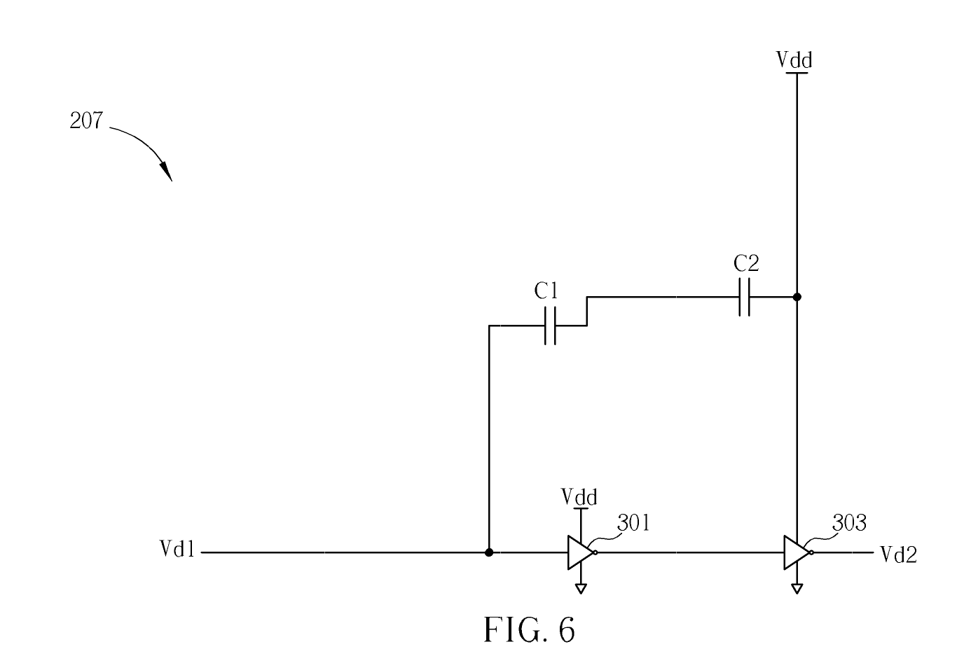

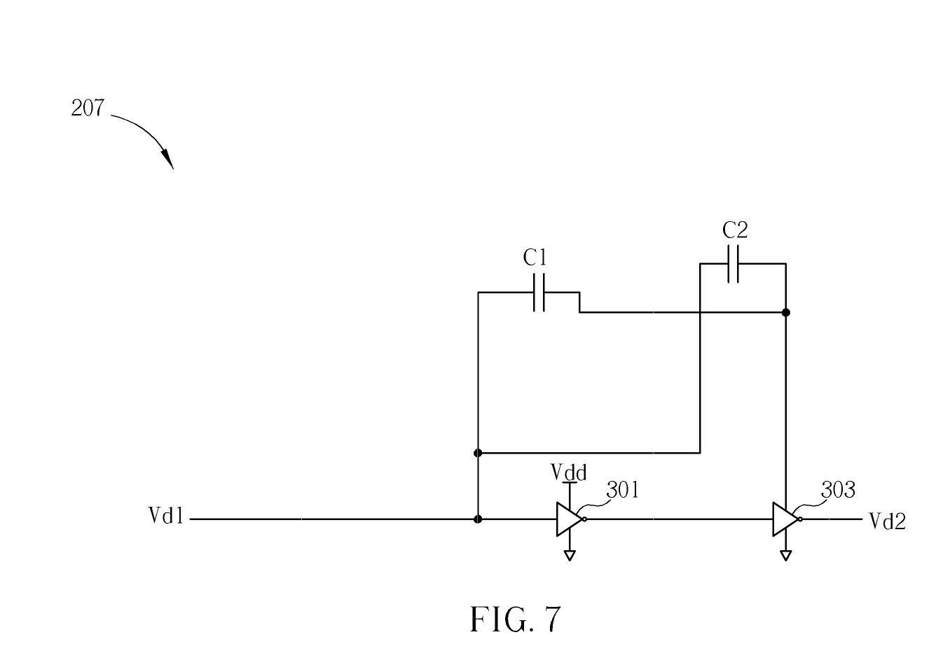

FIG. 6 and FIG. 7 are equivalent circuits of the switch driving circuit 207 when the detecting voltage Vc is at the low voltage level. When the detecting voltage Vc is at the low voltage level, the seventh switch is turned off. In FIG. 6, the control voltage Vd1 is set to be at the low voltage level, so that the first switch M1, the second switch M2, and the third switch M3 are turned on, and the fourth switch M4, the fifth switch M5, and the sixth switch M6 are turned off. Thus, the first power end of the second inverter 303 receives the supply voltage Vdd. The first end of the first capacitor C1 is electrically connected to the input end of the first inverter 301. The second end of the first capacitor C1 is electrically connected to the first end of the second capacitor C2. The second end of the second capacitor C2 is electrically connected to the first power end of the second inverter 303. At the time, the supply voltage Vdd charges the first capacitor C1 and the second capacitor C2. The voltage on the first end of the first capacitor C1 is at the low voltage level. The voltage on the second end of the second capacitor C2 is the supply voltage Vdd. When the capacitance of the first capacitor C1 is equal to the capacitance of the second capacitor C2, the voltage drops across the first capacitor C1 and the second capacitor C2 are both equal to (½×Vdd). In FIG. 7, the control voltage Vd1 is set to be at the high voltage level, so that the first switch M1, the second switch M2, and the third switch M3 are turned off, and the fourth switch M4, the fifth switch M5, and the sixth switch M6 are turned on. Consequently, the first end of the first capacitor C1 is electrically connected to the input end of the first inverter 301. The second end of the first capacitor C1 is electrically connected to the first power end of the second inverter 303. The first end of the second capacitor C2 is electrically connected to the input end of the first inverter 301. The second end of the second capacitor C2 is electrically connected to the first power end of the second inverter 303. When the control voltage Vd1 converts from the low voltage level to be the high voltage level, both the voltage drops across the first capacitor C1 and the second capacitor C2 are equal to (½×Vdd) at the time. Therefore, when the switch control circuit 206 generates control voltage Vd1 of the high voltage level for turning on the switch component 201 and the voltage level of the control voltage Vd1 is not high enough because the supply voltage is lower, the switch driving circuit 207 can provide the compensation voltage (1.5×Vdd) to the first power end of the second inverter 303 by means of the first capacitor C1 and the second capacitor C2. In this way, the driving voltage Vd2 rises high enough so as to avoid the turn-on resistance of the switch component 201 increasing.

In conclusion, the switch driving circuit includes a buffer module, a capacitor module, a first switch module, a second switch module, and a control module. The buffer module generates a driving voltage according to a control voltage. The first switch module is turned on when the control voltage is at a low voltage level to provide a supply voltage to the buffer module and charge the capacitor module by the supply voltage to generate a compensation voltage. The second switch module is turned on when the control voltage is at a high voltage level to provide the compensation voltage to the buffer module. The control module turns on the first switch module and turns off the second module to provide the supply voltage to the buffer module when the supply voltage is higher than a reference voltage. Therefore, when the supply voltage is at the low voltage level, the switch driving circuit can provide the compensation voltage to the buffer module by means of the first switch module and the second switch module, so as to generate the driving voltage of the high voltage level to drive the switch of the switch-mode DC/DC converter. In addition, the switch-mode DC/DC converter utilizing the switch driving circuit of the present invention can be a buck converter, a boost converter, or a buck-boost converter.

Those skilled in the art will readily observe that numerous modifications and alterations of the device and method may be made while retaining the teachings of the invention.

What is claimed is:

1. A switch driving circuit, comprising:
a buffer module, for generating a driving voltage according to a control voltage;
a capacitor module, electrically connected to the buffer module;
a first switch module, being turned on when the control voltage is at a low voltage level, for providing a supply voltage to the buffer module, and charging the capacitor module by the supply voltage so as to generate a compensation voltage;
a second switch module, turned on when the control voltage is at a high voltage level, for providing the compensation voltage to the buffer module; and
a control module, for turning on the first switch module and turning off the second switch module so as to provide the supply voltage to the buffer module when the supply voltage is higher than a reference voltage.

2. The switch driving circuit of claim 1, wherein the buffer module comprises:
a first inverter, having an input end for receiving the control voltage, an output end, a first power end for receiving the supply voltage, and a second power end electrically connected to a ground; and
a second inverter, having an input end electrically connected to the output end of the first inverter, an output end for outputting the driving voltage, a first power end electrically connected to the first switch module and the capacitor module, and a second power end electrically connected to the ground.

3. The switch driving circuit of claim 2, wherein the capacitor module comprises:
a first capacitor, having a first end electrically connected to the input end of the first inverter, and a second end electrically connected to the first switch module and the second switch module; and
a second capacitor, having a first end electrically connected to the first switch module and the second switch module, and a second end electrically connected to the first power end of the second inverter.

4. The switch driving circuit of claim 3, wherein the first switch module comprises:
a first switch, having a first end, a second end electrically connected to the input end of the first inverter, and a control end electrically connected to the control module;
a second switch, having a first end electrically connected to the first end of the second capacitor, a second end electrically connected the second end of the first capacitor, and a control end electrically connected to the control module; and
a third switch, having a first end for receiving the supply voltage, a second end electrically connected to the first power end of the second inverter, and a control end electrically connected to the control module.

5. The switch driving circuit of claim 4, wherein the first switch and the second switch are NMOS transistors, and the third switch is a PMOS transistor.

6. The switch driving circuit of claim 4, wherein the second switch module comprises:
a fourth switch, having a first end electrically connected to the first power end of the second inverter, a second end electrically connected to the second end of the first capacitor, and a control end electrically connected to the control module;
a fifth switch, having a first end electrically connected to the first power end of the second inverter, a second end electrically connected to the first end of the first switch, and a control end electrically connected to the control module; and
a sixth switch, having a first end electrically connected to the first end of the second capacitor, a second end electrically connected to the input end of the first inverter, and a control end electrically connected to the control module.

7. The switch driving circuit of claim 6, wherein the fourth switch, the fifth switch, and the sixth switch are PMOS transistors.

8. The switch driving circuit of claim 2, wherein the control module comprises:
a voltage-detecting circuit, for detecting if the control voltage is higher than the reference voltage;
a NOR gate, having a first input end electrically connected to the voltage-detecting circuit, a second input end electrically connected to the input end of the first inverter, and an output end electrically connected to the first switch module;
an OR gate, having a first input end electrically connected to the voltage-detecting circuit, a second end electrically connected to the output end of the first inverter, and an output end electrically connected to the second switch module; and
a seventh switch, having a first end electrically connected to the first switch module, a second end electrically connected to the ground, and a control end electrically connected to the voltage-detecting circuit.

9. The switch driving circuit of claim 8, wherein the voltage-detecting circuit comprises:
a first resistor, having a first end for receiving the supply voltage, and a second end;
a second resistor, having a first end electrically connected to the second end of the first resistor, and a second end;
a third resistor, having a first end electrically connected to the second end of the second resistor, and a second end electrically connected to the ground;
an operational amplifier, having a positive input end electrically connected to the second end of the first resistor, a negative input end for receiving the reference voltage, and an output end; and
a transistor, having a drain electrically connected to the second end of the second resistor, a source electrically connected to the ground, and a gate electrically connected to the output end of the operational amplifier.

10. The switch driving circuit of claim 8, wherein the seventh switch is an NMOS transistor.
